(19) United States
(12) Patent Application Publication
(10) Pub. No.: US 2018/0283992 A1
(43) Pub. Date: Oct. 4, 2018

(54) WHEEL CONDITION MONITORING

(71) Applicant: Alireza Alemi, Tehran (IR)

(72) Inventor: Alireza Alemi, Tehran (IR)

(21) Appl. No.: 15/990,239

(22) Filed: May 25, 2018

Related U.S. Application Data
(60) Provisional application No. 62/512,081, filed on May 29, 2017.

(51) Int. Cl. G01M 17/10

(52) U.S. Cl. CPC G01M 17/10

(57) ABSTRACT

A system and method for detecting and identifying defects of a railway wheel may include a plurality of sensors mounted on a rail of a railway track, where each sensor may be configured to collect samples from a portion of the railway wheel circumference and generate a sensor signal including an array of the samples. The system may further include a signal processing unit coupled with the plurality of sensors. The signal processing unit may be configured to process arrays of samples received from the plurality of sensors to detect and identify the defects of the railway wheel.

### CROSS-REFERENCE TO RELATED APPLICATION

This application claims the benefit of priority from pending U.S. Provisional Patent Application Ser. No. 62/512,081, filed on May 29, 2017, and entitled “WHEEL CONDITION MONITORING,” which is incorporated herein by reference in its entirety.

### TECHNICAL FIELD

The present disclosure generally relates to railway wheels condition monitoring, and particularly to methods and systems for detecting and identifying defects in a train wheel.

### BACKGROUND

Railway wheels are critical components and their maintenance is therefore a vital task. From the safety point of view, the defects of wheelsets are among the main reasons of train accidents. Wheel defects change wheel-rail contact and sometimes generate a high impact force detrimental to the track and train. Unexpected wheel failures also reduce availability of trains and cause delay in transport services that reduces reliability of the railway system. To establish an effective and efficient maintenance plan, the condition of the wheels should be accurately measured or estimated.

A wheel defect produces a contact force that is transferred to the track and vehicle. Therefore, wheel condition can be indirectly estimated by measuring wheel and rail responses such as strain, vibration, and acoustic. Installing sensors on every wheel is challenging due to expense, implementation and maintenance. For this reason, track-side measurement may be utilized to measure rail responses, such as strain and vibration, by a sensor or a set of sensors to estimate the condition of the in-service wheels.

Different methods may be used to detect wheel defects based on the sensor signals. For example, some wheel defects such as flats generate high frequency components in the signals measured by sensors. Therefore, a defect can be detected by looking at high-pass filtered signals. This method detects only the defect without any further information about its type and severity, and can be used only if the defects generate signals containing high frequency components. Therefore, long-wave defects such as periodic out-of-roundness of the wheels cannot be detected and identified by this method. In another example, the magnitude of the data acquired by the sensors, i.e., peak value of the sensor signals, is used to quantify wheel defects. However, there are considerable fluctuations in acceleration and force peaks especially when the trains travel with higher velocities and the wheels have more severe defects. One way to deal with the problem of fluctuation is to exclude the effect of axle load on the fluctuations and variations in the magnitudes of the force or acceleration peaks. In an example, a force ratio may be defined by dividing the peak force by the average force collected by multiple sensors, or alternatively, a dynamic force may be defined by subtraction between peak force and average force. Still, in spite of excluding the effect of axle load, train velocity is an out-of-control parameter that causes variation in the magnitudes of the peak force, the force ratio, and dynamic force. By utilizing peak force, dynamic force and force ratio criteria, one can detect only the severe defects that greatly contribute to the contact force.

Another limitation is that the above-mentioned criteria fail to distinguish between the defect types. They classify the wheel into healthy and defective. The rate and mechanism of the wheel degradation are influenced by defect type. Therefore, estimating the defect type is significant to provide a comprehensive estimate of wheel condition. In addition, a severe defect will dominate the other defects of a wheel. Therefore, the dynamic force and the force ratio of a wheel with multiple defects including a severe defect can be smaller than those of a wheel with a similar severe defect, because the average of the contact force for the first wheel is higher than the second one. Therefore, these criteria can lead to a false interpretation. Another weakness of the currently utilized criteria is difficulty in detecting the minor defects such as spalling, periodic out-of-roundness and small shelling at an early stage.

Therefore, there is a need in the art for developing an effective and reliable method for detecting and identifying the wheel defects. There is further a need for methods that provide more information from wheel defects to be used for defect detection and identification.

### SUMMARY

In one general aspect, the present disclosure relates to a system/method for detecting and identifying defects of a railway wheel. The system may include a plurality of sensors mounted on a rail of a railway track, where each sensor may be configured to collect samples from a portion of the railway wheel circumference and generate a sensor signal including an array of the samples. The system may further include a signal processing unit coupled with the plurality of sensors. The signal processing unit may include: a processor and a memory that may be configured to store executable instructions to cause the processor to perform operations to process arrays of samples received from the plurality of sensors to detect and identify the defects of the railway wheel. The operations may include: mapping the array of samples received from each of the plurality of sensors over the railway wheel circumference by calculating a corresponding position of each sample of the array of samples in a circumferential coordinate of the railway wheel, the mapped arrays of samples from the plurality of sensors forming a reconstructed signal, and classifying the reconstructed signal, based at least in part on a defect type and a defect severity.

According to one or more implementations, calculating a corresponding position of each sample of the array of samples in a circumferential coordinate of the railway wheel may include calculating the corresponding position by an operation defined by:

$${Y}_{m , n} = {X}_{m} - ( {L}_{w} \times ⌊ \frac{{X}_{m}}{{L}_{w}} ⌋ ) + ( ( n - 1 ) \times λ )$$

where, Y_{m,n} is the corresponding position of an nth sample in the array of samples picked up by an mth sensor, Xₘ is the position of the mth sensor with respect to a first sensor, L_{w} is the railway wheel circumference length, λ is the space distance between the samples, and operator [ ] the round operator toward the nearest integer less than or equal to the term between the operator.

According to an implementation, the spacial distance between the samples is calculated by dividing the railway wheel velocity by sampling frequency of the plurality of sensors.

According to one or more implementations, classifying the reconstructed signal, based at least in part on a defect type and a defect severity may include generating a reference dataset including a plurality of reference reconstructed signals from railway wheels with known defect types and seventies, calculating reference features of the reference dataset, the reference features including peak values of the reference reconstructed signals, dynamic values of the reference reconstructed signals, ratios of the peak values to average values, interpolated reference reconstructed signals, dynamic signals, ratio signals, normalized signals, Fourier transforms of the interpolated reconstructed signals, Fourier transforms of the dynamic signals, Fourier transforms of the ratio signals, Fourier transforms of the normalized signals, and combinations thereof; training a classifier by the reference features of the reference reconstructed signals, and classifying the reconstructed signal by the trained classifier.

According to some implementations, classifying the reconstructed signal by the trained classifier may include extracting features of the reconstructed signal, the features of the reconstructed signal including a peak value of the reconstructed signal, a dynamic value of the reconstructed signal, a ratio of the peak value to average value of the reconstructed signal, interpolated reference reconstructed signal, dynamic signal, ratio signal, normalized signal, a Fourier transform of the interpolated reconstructed signal, a Fourier transforms of the dynamic signal, a Fourier transforms of the ratio signal, a Fourier transforms of the normalized signal, and combinations thereof, and identifying a defect type and severity for the reconstructed signal by comparing the features of the reconstructed signal with the reference features of the reference reconstructed signals by the classifier.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an implementation of a system for detecting and identifying defects of a railway wheel;

FIG. 2A illustrates a sensor mounted on a rail above a sleeper, according to one or more implementations of the present disclosure;

FIG. 2B illustrates an output signal of a sensor, according to an implementation of the present disclosure;

FIG. 3A illustrates an implementation of a system for detecting and identifying defects of an exemplary railway wheel;

FIG. 3B illustrates a rail response measured at different positions along the rail, according to an implementation of the present disclosure;

FIG. 4 illustrates a block diagram of an implementation of a railway wheel defect detection and identification system;

FIG. 5 illustrates an implementation of a method for processing a response signal matrix for detecting and identifying the defects of a railway wheel;

FIG. 6 illustrates an implementation of a classification method;

FIG. 7 illustrates a test rig for modeling the wheel-rail interaction, according to an implementation of the present disclosure;

FIG. 8A illustrates a raw signal of a strain sensor during passage of a healthy wheel over a strain sensor, according to an implementation of the present disclosure;

FIG. 8B illustrates raw signals of six strain sensors in a first round of a healthy wheel rotation over the strain sensors, according to an implementation of the present disclosure; and

FIG. 9 illustrates reconstructed signals for a healthy wheel and three defective wheels, according to an implementation of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

The following disclosure describes techniques and systems for detecting and identifying railway wheel defects by reconstructing wheel-rail contact signals that are measured by a number of sensors mounted on a railway track. The disclosed systems and techniques may include a signal processing unit that may be utilized for mapping the wheel-rail contact signals over the railway wheel circumference based at least in part on the railway wheel circumference and configuration of the sensors mounted on the railway track. The mapped signals may form a reconstructed informative signal, which may then be utilized for detecting and identifying the railway wheel defects. The reconstructed informative signal provides more features that may be attributed to different defects with different severity and thereby allows classifying wheel condition into different classes of defect types and seventies despite uncontrollable variations in the reconstructed signals due to different operating conditions in the field.

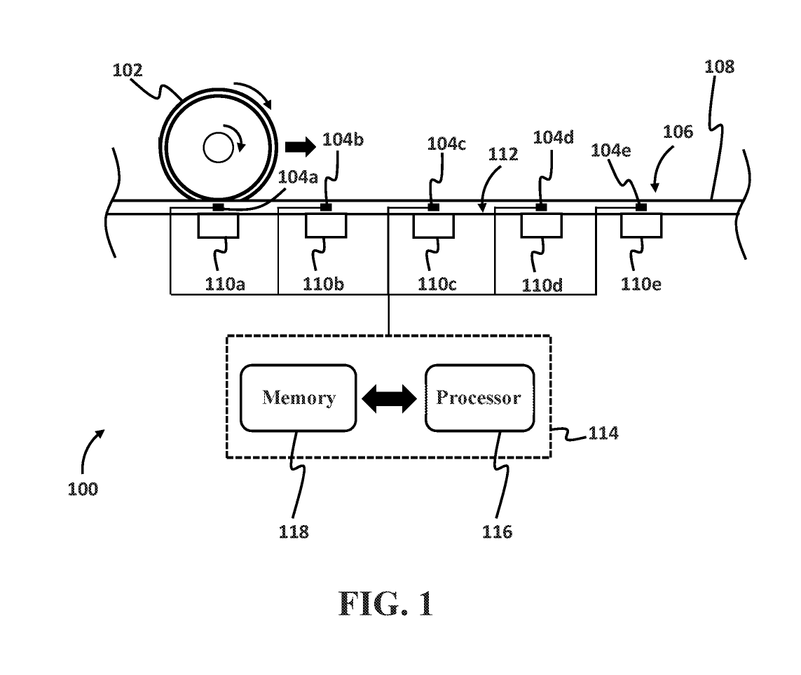

FIG. 1 illustrates an implementation of a system 100 for detecting and identifying defects of a railway wheel 102. According to one or more implementations, the system 100 may include a number of sensors 104a-e that may be mounted on a railway track 106. The sensors 104a-e may be configured to measure wheel-rail interactions at different positions along the railway track 106. In an example, the sensors 104a-e may be mounted on a rail 108 above sleepers 110. In other examples, the sensors 104a-e may either be mounted on the sleepers 110a-e or on a bay between two consecutive sleepers, such as bay 112 between sleepers 110c and 110d. The sensors 104a-e may measure one of force, displacement, bending moment, or shear strain. It should be understood that the wheel-rail contact interactions or in other words the railway track 106 response to the wheel 102 passing over the rail 108 may be sensed or otherwise sampled by the sensors 104a-e in any of the above-mentioned forms, namely, the force exerted by the wheel 102 on the rail 108 or each of sleepers 110a-e, the displacement of the rail 108 or each of sleepers 110a-e, the bending moment of the rail 108 or each of sleepers 110a-e, or the shear stress measured on the neutral axis of the rail 108.

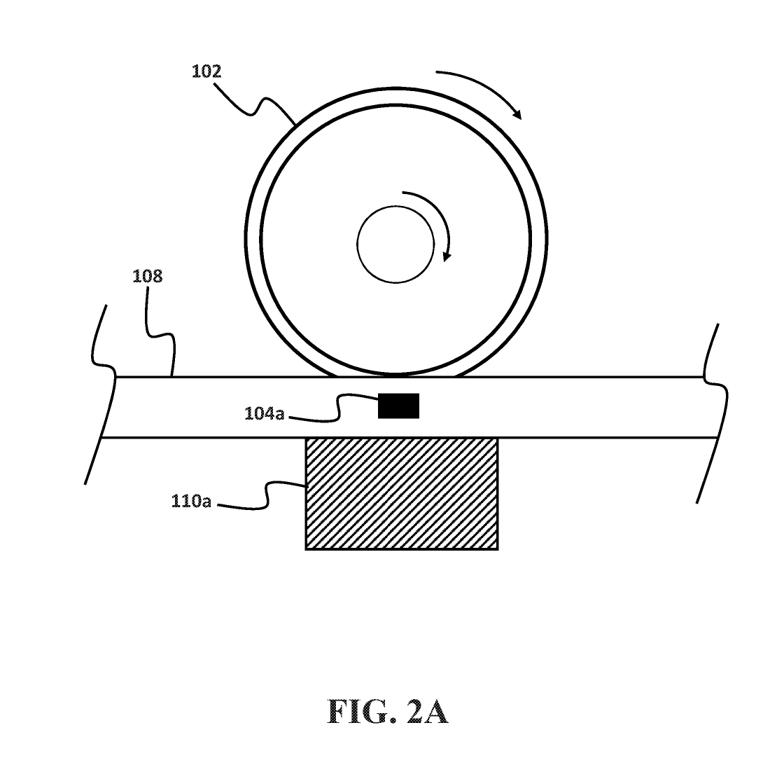

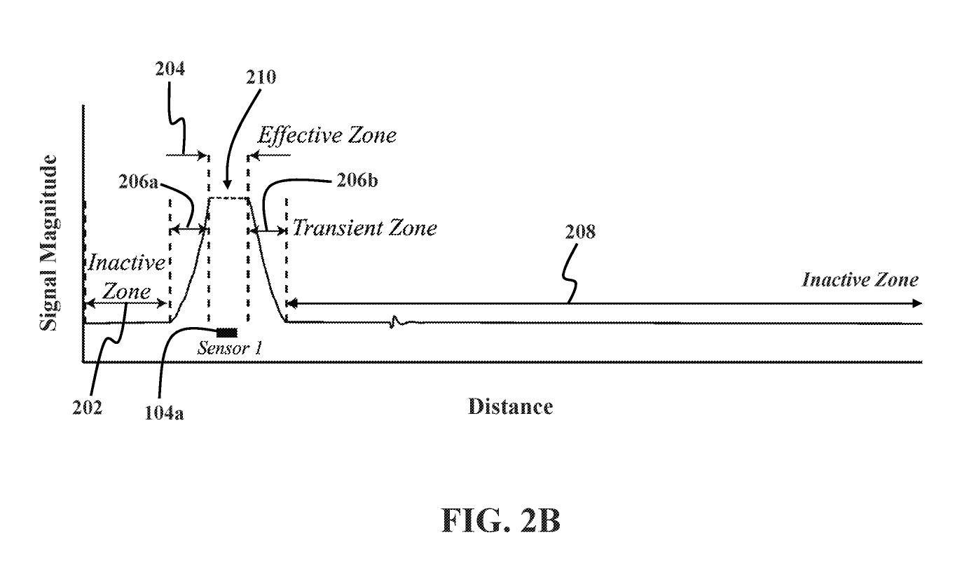

FIG. 2A illustrates the sensor 104a mounted on the rail 108 above the sleeper 110a, according to one or more implementations of the present disclosure. FIG. 2B illustrates an output signal of the sensor 104a, according to an implementation of the present disclosure.

Referring to FIGS. 2A and 2B, each of the sensors mounted on the rail 108, such as the sensor 104a, has several measurement zones with respect to the wheel 102. The measurement zones may include a first inactive zone 202 in which the wheel 102 is away from the sensor 104a generating a zero output signal; a first transient zone 206a in which the wheel 102 approaches the sensor 104a causing an increase in the output signal; an effective zone 204, in which the wheel 102 is on top of the sensor 104a (as illustrated in FIG. 2A); a second transient zone 206b in which the wheel 102 moves away from the sensor 104a causing a decrease in the output signal; and a second inactive zone 208 in which the wheel 102 has moved away from the sensor 104a generating a zero output signal. The sensor 104a similar to all the other sensors that are mounted on the rail 108 collects data or in other words samples in the measurement zones 202, 204, 206a-b, and 208, but only samples 210 measured in the effective zone 204 may be utilized to form the defect pattern of the wheel 102. Since the effective zone 204 is smaller than the circumference of the wheel 102, the sensor 104a may collect only the samples 210 from a portion of the circumference of the wheel 102. However, due to utilization of a plurality of sensors in the system 100, the entire circumference of the wheel 102 may be sampled.

Referring back to FIG. 1, according to one or more implementations, the system 100 may further include a signal processing unit 114 that may be coupled with the sensors 104a-e. The signal processing unit 114 may include a processor 116 and a memory 118. According to an implementation, the memory 118 may be configured to store executable instructions to cause the processor 116 to process the samples collected by the sensors 104a-e for detecting and identifying the defects of the wheel 102. According to one or more implementations, the processor 116 may process the samples by first mapping the samples collected by each of the sensors 104a-e over the circumference of the wheel 102 in order to reconstruct a signal for the wheel 102, and then identifying the defects of the wheel 102 by attributing the reconstructed signal to the wheel defects. According to an implementation, the memory 118 may further include a defect identification model that utilizes pattern recognition methods to identify the defects of the wheel 102, and once executed, cause the processor 116 to classify the reconstructed signal of the wheel 102 into different classes of defect types and seventies.

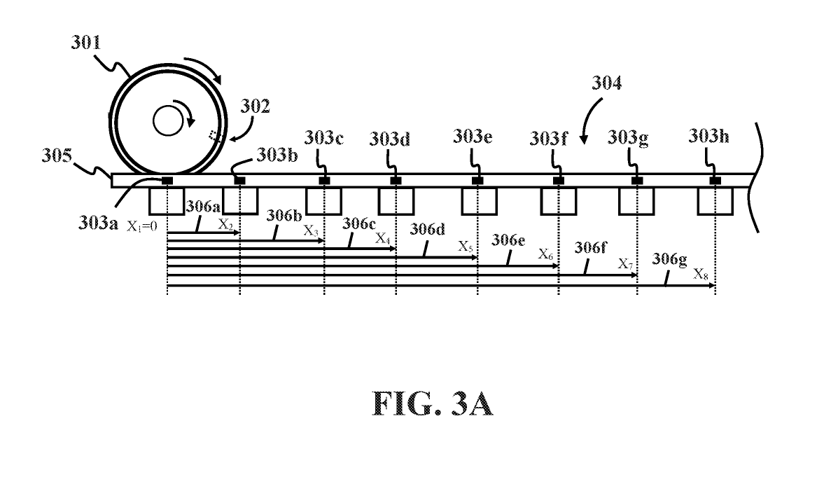

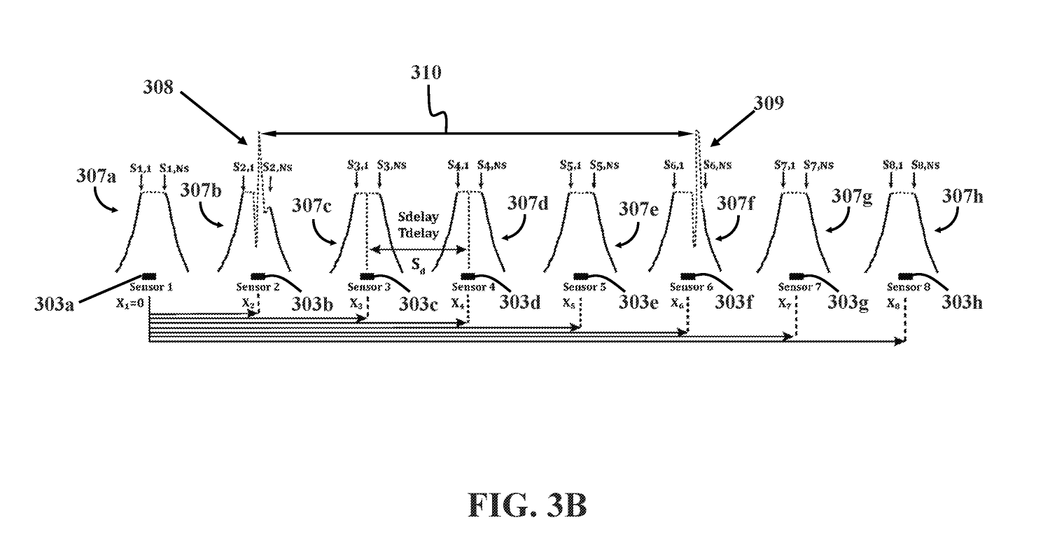

FIG. 3A illustrates an implementation of a system 300 for detecting and identifying defects of an exemplary railway wheel 301. The system 300 may be similar to the system 100 of FIG. 1, in which, for simplicity, the signal processing unit is not explicitly illustrated. Referring to FIG. 3A, according to one or more implementations, the system 300 may include a number of sensors 303a-h that are mounted on a railway track 304. The exemplary railway wheel 301 that may have a defect 302 passes over the sensors 303a-h and each sensor collects a number of samples from a portion of the circumference of the wheel 301 that passes over the corresponding effective zone of that sensor.

Referring to FIG. 3A, the sensors 303a-h may be mounted on predetermined positions along the railway track 304. The force exerted by the wheel 301 is transferred to a rail 305 and sleepers and then the transferred force is picked up by the sensors 303a-h. In order for the sensors 303a-h to sample in identical conditions, the predetermined positions may include positions on the railway track 304 with identical transfer functions. The rail-sleeper structure of the railway track 304 may cause dissimilar rail responses in different points along the rail 305. In this case, the output signals of the sensors 303a-h may be calibrated with respect to the position of the sensors 303a-h along the longitudinal direction. In an example, a symmetric arrangement of the sensors 303a-h may be utilized by mounting the sensors 303a-h in identical positions, such as on the rail 305 above each sleeper (as shown in FIG. 3A), on the sleeper, or on the bay between two consecutive sleepers. Referring to FIG. 3A, according to an implementation, each of the sensors 303a-h is mounted on the rail 35 with a position which may be identified by the longitudinal distance of that sensor from the first sensor. The longitudinal distance of each sensor is designated by Xₘ, m being the number of that sensor. For example, longitudinal distance of the sensor 303a is designated by X₁ and is zero; longitudinal distance 306a of the sensor 303b is designated by X₂; longitudinal distance 306b of the sensor 303c is designated by X₃; longitudinal distance 306c of the sensor 303d is designated by X₄; longitudinal distance 306d of the sensor 303e is designated by X₅; longitudinal distance 306e of the sensor 303f is designated by X₆; longitudinal distance 306f of the sensor 303g is designated by X₇; and longitudinal distance 306g of the sensor 303h is designated by X₈.

FIG. 3B illustrates the rail response measured at different positions along the rail, according to an implementation of the present disclosure. The sensors 303a-h measure the rail response at different positions along the rail. For example, rail response 307a is measured by the sensor 303a; rail response 307b is measured by the sensor 303b; rail response 307c is measured by the sensor 303c; rail response 307d is measured by the sensor 303d; rail response 307e is measured by the sensor 303e; rail response 307f is measured by the sensor 303f; rail response 307g is measured by the sensor 303g; and rail response 307h is measured by the sensor 303h. Each sensor collects multiple samples from a specific portion of the wheel circumference forming an array of samples. Each sample of the array of samples collected by each sensor may be a combination of the wheel signal w(t) and possibly the defect signal g(t). The number of samples collected in the effective zone of each sensor may be identical as the wheel passes over the sensors with a constant velocity and the sensors sample with an identical sampling frequency fₜ.

According to the implementation shown in FIGS. 3A and 3B, the defect 302 is picked up by sensors 303b and 303f. The rail response 307b includes both the wheel signal and the defect signal, where the defect signal is visible as peaks 308. The defect signal is picked up one more time by the sensor 303f and is visible as peaks 309. It should be understood that the defect signal is a periodic signal which is replicated in every revolution of the wheel 301. The distance 310 between the peaks 308, 309 indicates the wheel circumference.

An informative signal may be reconstructed by mapping the samples received from different sensors over the circumferential coordinate using the wheel circumference and the sensors configuration and arrangement, according to one or more implementations of the present disclosure. Referring to FIGS. 3A and 3B, the sensors 303a-e sample a first revolution of the wheel 301 and sensors 303f-h sample a second revolution of the wheel 301. The sample arrays collected from the sensors 303f-h fill the data gaps between the sample arrays collected by sensors 303a-e. By extending the sampling procedure to other revolutions of the wheel 301, more sample arrays from different portions of the wheel 301 may be collected to fill the missing data not picked up or sampled by previous sensors.

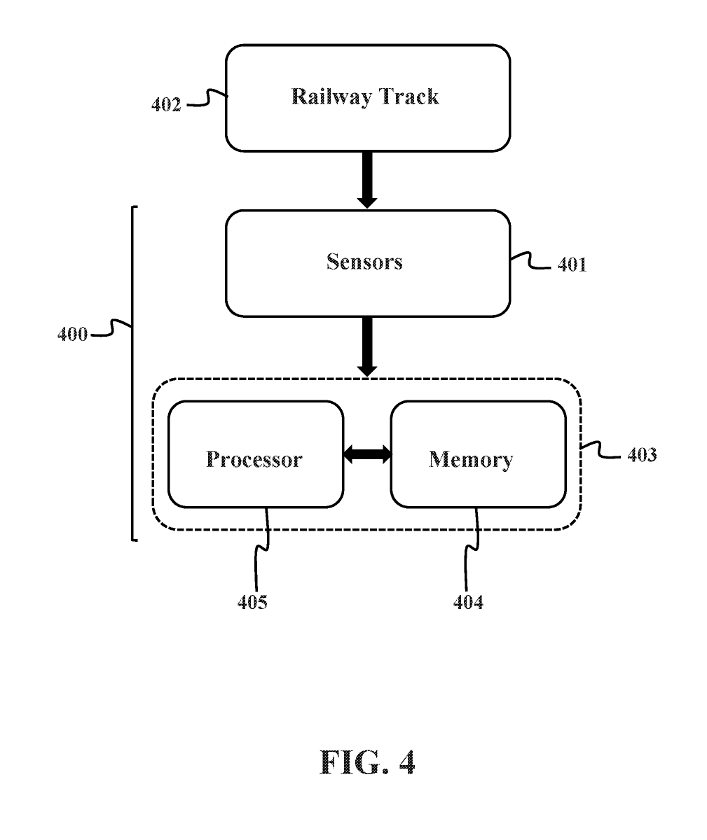

FIG. 4 is a block diagram of an implementation of a railway wheel defect detection and identification system 400. According to some implementations, the railway wheel defect detection and identification system 400 may be similar to the system 100 of FIG. 1 and the system 300 of FIG. 3A.

Referring to FIG. 4, the railway wheel defect detection and identification system 400 may include multiple sensors 401 mounted on a railway track 402 to measure the responses of the railway track 402 to a railway wheel passing over the railway track 402. According to an implementation, for an arrangement of m sensors, where each sensor picks up n samples in its corresponding effective zone, the measured responses or samples may include an m by n response signal matrix (S_{m,n}), where each row consists of an array of n samples picked up by each sensor. The railway wheel defect detection and identification system 400 may further include a signal processing unit 402 that may be similar to the signal processing unit 114 of FIG. 1. Referring to FIG. 4, according to one or more implementations, the signal processing unit 403 may include a memory 404 and a processor 405. According to an implementation, the memory 404 may be configured to store executable instructions to cause the processor 405 to process the response signal matrix (S_{m,n}) for detecting and identifying the defects of the railway wheel.

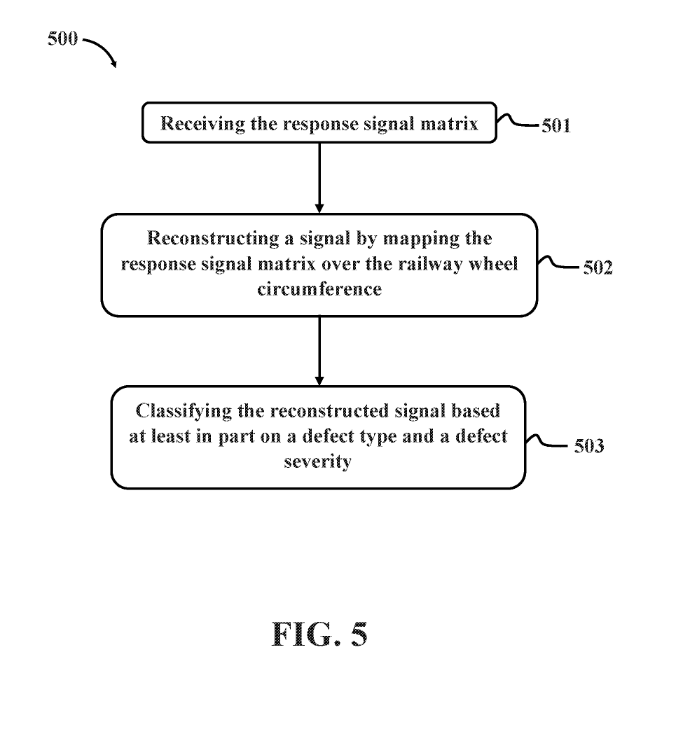

FIG. 5 illustrates an implementation of a method 500 for processing a response signal matrix (S_{m,n}) for detecting and identifying the defects of a railway wheel. The method 500 may include a step 501 of receiving the response signal matrix (S_{m,n}); a step 502 of reconstructing a signal by mapping the response signal matrix (S_{m,n}) over the railway wheel circumference; and a step 503 of classifying the reconstructed signal based at least in part on a defect type and a defect severity. Referring to FIGS. 4 and 5, the executable instructions stored on the memory 404 may include the method 500 which is executed by the processor 405.

Referring to FIG. 5, according to one or more implementations, the step 502 of reconstructing a signal by mapping the response signal matrix over the railway wheel circumference may include calculating a corresponding position of each sample of the response signal matrix in a circumferential coordinate of the wheel. According to an implementation, the corresponding position of each sample of the response signal matrix in the circumferential coordinate of the wheel may be calculated by Equations (1) and (2) below:

$$\begin{matrix}{Y}_{m , n} = {Y}_{m , 1} + ( ( n - 1 ) \times λ ) & Equation ( 1 ) \\ {Y}_{m , 1} = {X}_{m} - ( {L}_{w} \times ⌊ \frac{{X}_{m}}{{L}_{w}} ⌋ ) & Equation ( 2 )\end{matrix}$$

In the Equations (1) and (2) above, Y_{m,n} is the corresponding position of the nth sample picked up by the mth sensor and Y_{m,1} is the corresponding position of the first sample collected by the mth sensor. Xₘ designates the position of the mth sensor with respect to the first sensor as was described in detail in connection with FIG. 3A. L_{w} designates the wheel circumference length and the operator [ ] is the rounding operator toward the nearest integer less than or equal to the term between the operator. λ designates the space distance between the samples. According to an implementation, the space distance between the samples (λ) may be calculated with Equation (3) below:

$$λ = \frac{V}{{f}_{t}} \qquad Equation ( 3 )$$

In the Equation (3) above, V is the velocity of the train passing over the sensors and fₜ is the sampling frequency of the sensors. λ determines the space resolution of the measurement in the space domain. For example, when a sensor is sensing by 10 kHz sampling frequency (fₜ), for a train with 10 m/s velocity (V), the spacial distance between the samples (λ) is 1 mm.

According to one or more implementations, once the corresponding position (Y_{m,n}) of each sample of the response signal matrix (S_{m,n}) in the circumferential coordinate of the railway wheel is calculated, a reconstructed signal (ψₛ) is obtained that contains both the magnitude and the position of each sample as follows:

ψₛ=[Y_{m,n}, S_{m,n}] Equation (4)

This reconstructed signal (ψₛ) is used in a defect identification model to classify the defective wheels.

Referring to FIG. 5, according to one or more implementations, the step 503 of classifying the reconstructed signal based at least in part on a defect type and a defect severity may include applying a pattern recognition process on reference reconstructed signals from different known defect types with known severities to generate a known dataset; training a classifier by the known dataset; and using the trained classifier to identify a defect type and severity for the reconstructed signal.

For purposes of explanation, pattern recognition terminologies are adapted hereinafter. Reconstructed signals are called objects. Each object may have a defect class. The defect class may include an individual defect type with a certain severity. For example, a class may include a defect such as a flat with 40 mm length and another class may include a defect such as a flat with 60 mm length, while another class includes a defect such as out-of-roundness to a certain extent. The objects with known classes are called known data, while the objects without known classes are called unseen data. A classifier, such as a support vector machine (SVM), k-nearest neighbor algorithm (k-NN), and the like, may be trained by the known data to classify the unseen data.

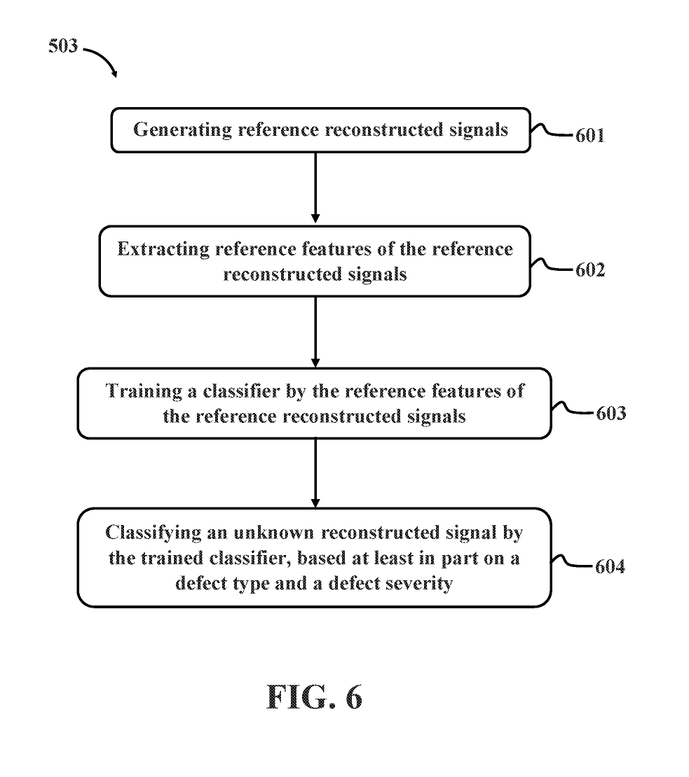

FIG. 6 illustrates an implementation of the step 503 of method 500 as was described in connection with FIG. 5. Referring to FIG. 6, according to one or more implementations, the step 503 may include a step 601 of generating reference reconstructed signals; a step 602 of extracting reference features of the reference reconstructed signals; a step 603 of training a classifier by the reference features of the reference reconstructed signals; and a step 604 of classifying an unknown reconstructed signal by the trained classifier, based at least in part on a defect type and a defect severity.

Referring to FIG. 6, according to an implementation, step 601 of generating reference reconstructed signals, i.e., known data, may include generating reference reconstructed signals from different known defect types with known seventies. For each defect class, the wheel defect detection and identification system 400 of FIG. 4 may be utilized for several reference wheels with known defects and seventies in order to generate several reference reconstructed signals or known objects. Theses known objects may form a known dataset.

In step 602, according to an implementation, feature extraction is applied to the known dataset generated in step 601 and the known dataset is encoded by different features as follows. As mentioned before, the three statistical features that may be utilized for estimating the wheel condition are the peak value, dynamic value, and the ratio of the peak to the average. These features are represented by single values and these values are used with some predetermined thresholds to classify the wheels into safe and detrimental classes. However, the train velocity and axle load may influence these values and have negative effects on the classification process.

As disclosed herein, reconstructing a signal from multiple signals picked up by multiple sensors by a system like the wheel defect detection and identification system 400 allows to utilize these three statistical features (peak value, dynamic value, and the ratio of the peak to the average) along with new features defined based on the reconstructed signal. These new features may include, but are not limited to, features such as the reconstructed signal itself, a dynamic signal, a ratio signal, a normalized signal, a Fourier transform of the reconstructed signal, a Fourier transform of the dynamic signal, a Fourier transform of the ratio signal, and a Fourier transform of the normalized signal. Table 1 presents the definitions and formula of some of the features introduced above.

TABLE 1

| Feature | Formula |
|---|---|
| Peak Value | arg maxₖ (ψₛ) |
| Dynamic Value | arg maxₖ (ψₛ) − μₛ |
| Ratio Value | $\frac{arg {max}_{k} ( {ψ}_{s} )}{{μ}_{s}}$ |
| Reconstructed Signal | ψₛ^{*}(k) |
| Dynamic Signal | ψₛ^{*}(k) − μₛ |
| Ratio Signal | $\frac{{ψ}_{s}^{*} ( k )}{{μ}_{s}}$ |
| Normalized Signal | $\frac{{ψ}_{s}^{*} ( k ) - {μ}_{s}}{{σ}_{s}}$ |
| Fourier Transform of the Reconstructed Signal | F(ψₛ^{*}(k)) |
| Fourier Transform of the Dynamic Signal | F(ψₛ^{*}(k) − μₛ) |
| Fourier Transform of the Ratio Signal | $F ( \frac{{ψ}_{s}^{*} ( k )}{{μ}_{s}} )$ |
| Fourier Transform of the Normalized Signal | $F ( \frac{{ψ}_{s}^{*} ( k ) - {μ}_{s}}{{σ}_{s}} )$ |

In Table 1 above, arg max represents an arguments of the maxima function, μₛ represents an average value of the signals, σₛ represents the standard deviation of the signals, and ψₛ* represents an interpolated reconstructed signal. The interpolated reconstructed signal is the reconstructed signal in which missing data in the circumferential coordinate of the wheel are interpolated to form an interpolated signal with uniformly distributed samples over the circumference of the wheel.

Referring to FIG. 6, according to an implementation, once the reference features are extracted or otherwise calculated as was described in connection with step 602, step 503 may move to step 603 of training a classifier by the reference features. A classifier, such as an SVM, k-NN, and the like, may be trained by the reference features. Since collecting data from defective wheels and then reconstructing the reference signals is expensive, the number of reference signals may be small. In an example, an SVM may be a suitable classifier for datasets with small sample sizes and high dimensional feature spaces.

Referring to FIG. 6, according to one or more implementations, step 604 of classifying an unknown reconstructed signal by the trained classifier, based at least in part on a defect type and a defect severity, may include applying a classification process on the reconstructed signal of the wheel with an unknown defect using the trained classifier. First, features of the reconstructed signal are extracted similar to what was described for reference signals in connection with step 602. Then, the classifier finds a defect class for the reconstructed signal by finding the nearest reference features to the features of the reconstructed signal.

### EXAMPLE

In this example, the railway wheel defect detection and identification system is validated using experimental data generated by a laboratory test rig. The test rig has been designed and constructed to model the wheel-rail interaction and to generate the real data required for the wheel defect detection and identification system of the present disclosure.

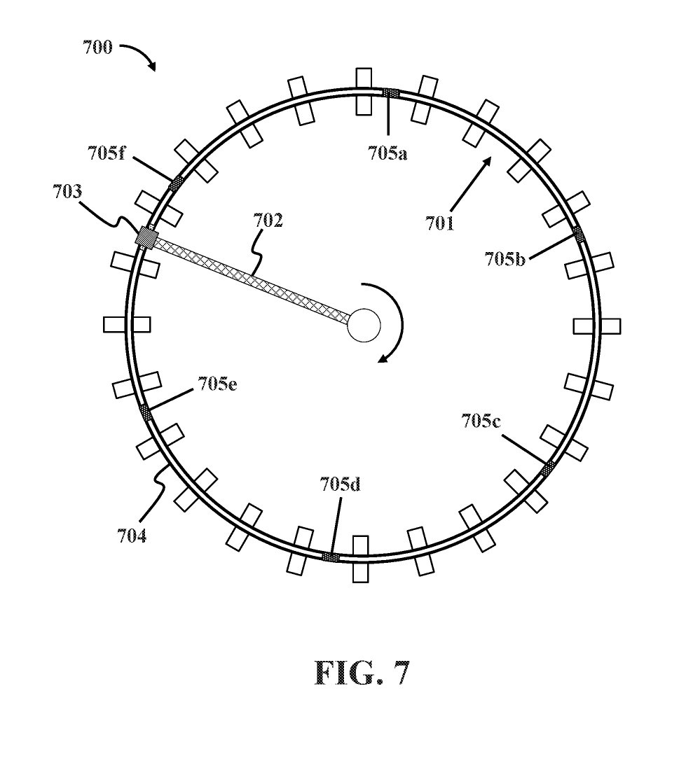

FIG. 7 illustrates a test rig 700 for modeling the wheel-rail interaction, according to an implementation of the present disclosure. Referring to FIG. 7, the test rig 700 may include a circular railway track 701, a rotating arm 702, a railway wheel 703 secured at a distal end of the rotating arm 702 and movable on the circular railway track 701. The circular railway track 701 includes a circular aluminum rail 704 with a rectangular profile (15 by 20 mm), an inner diameter of 992.5 mm and an outer diameter of 1022.5 mm. The wheel 703 may be a steel railway wheel with a diameter of 100 mm.

Referring to FIG. 7, according to an implementation, six general-purpose strain sensors 705a-f were installed under the rail 704 in the bay between the sleepers in the symmetric positions with 60° intervals. The rail 704 was polished and the sensors 705a-f were directly bonded to the rail 704. The overall length of the sensors 705a-f was 9.83 mm and gauge length was 4.75 mm with linear pattern. The sensors 705a-f measured the rail 704 bending strain generated by the wheel-rail contact force by 3 kHz sampling frequency. The sensors 705a-f were equally spaced apart and were connected through an amplifier and a data acquisition device (DAQ) to a signal processing unit similar to the signal processing unit 402 of FIG. 4.

Four wheels were tested including a healthy wheel, two flat wheels, and a wheel with periodic out-of-roundness. The wheels had a diameter of 100 mm and a convex profile. To create the defects on the wheels, first, three defective wheels were machined to have flat profiles. This process reduced the wheel diameter to 99.01 mm. Then, the defects were made on the wheels. A first defective wheel had a large flat with 6.6 mm length and 0.11 mm depth. A second defective wheel had a small flat with 4.4 mm length and 0.05 mm depth. The third defective wheel had a third order periodic out-of-roundness with 98.92 mm diameter and 0.08 mm amplitude. The healthy wheel, the first defective wheel, the second defective wheel, and the third defective wheel may be removably mounted on the distal end of the movable arm one by one.

The strain sensors 705a-f measure the rail 704 bending response, and their outputs are voltage signals. These voltage signals are voltage variations over time due to the wheel 703 passing over the rail 704. The raw voltage output of the sensors 705a-f is sent to the signal processing unit where a signal is reconstructed as was described in detail in connection with Equations (1)-(4).

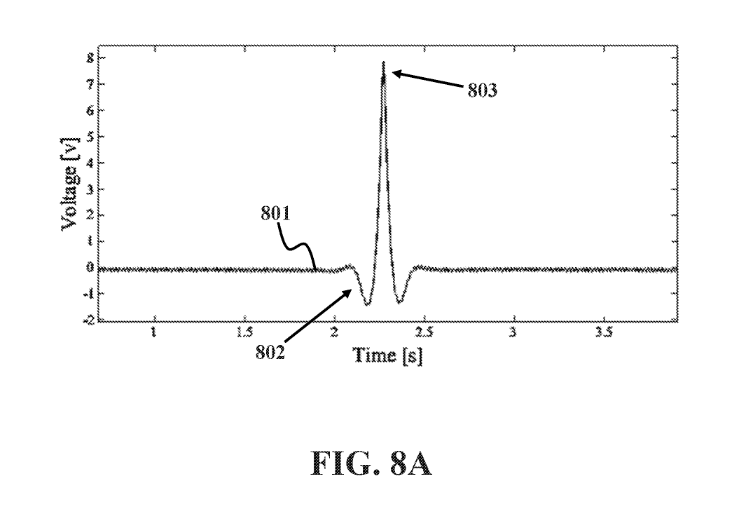

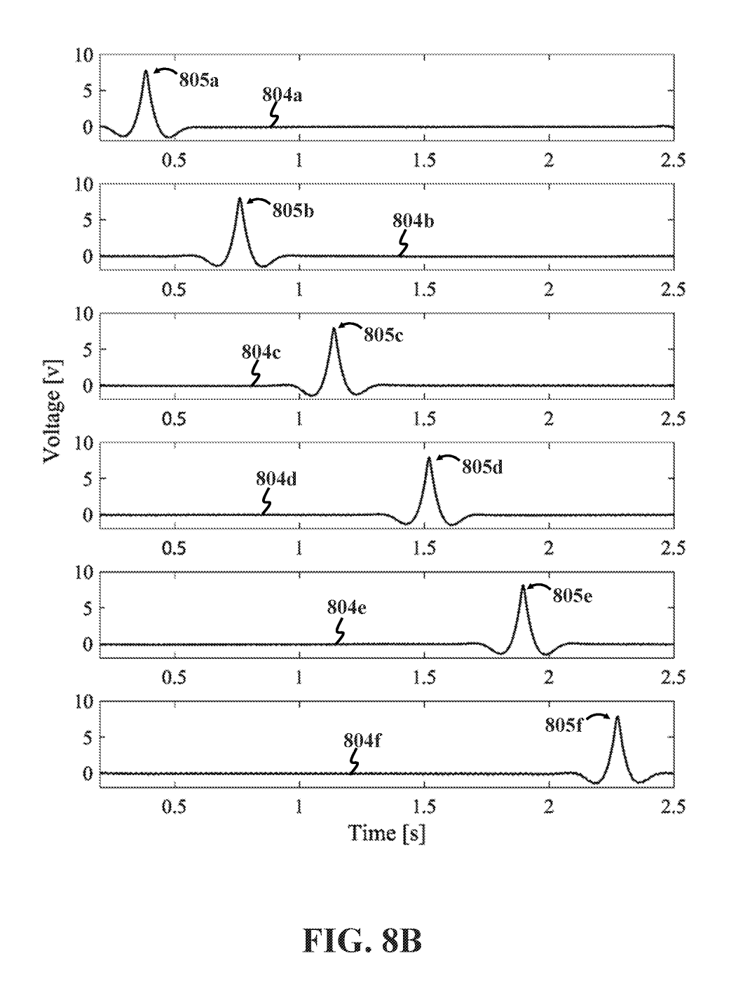

FIG. 8A illustrates a raw signal 801 of a strain sensor during the passage of the healthy wheel over the strain sensor. Referring to the raw signal 801, when the wheel is far from the strain sensor, the output of the strain sensor is 0 V. As the wheel approaches the strain sensor, the rail goes up and compresses the sensor and produces a negative output (referred to by reference numeral 802). When the wheel goes on top of the sensor, the output of the sensor increases to a maximum 803 depending on the wheel-rail contact force. When the wheel is healthy and is moving with constant velocity, the signals measured by the multiple sensors will have nearly identical shapes and magnitudes but with a delay.

FIG. 8B illustrates raw signals 804a-f of the six strain sensors 705a-f in a first round of the healthy wheel rotation over the strain sensors 705a-f. Each sensor measures a portion of the healthy wheel. Referring to FIG. 8B, the raw signal 804a is measured by the strain sensor 705a; the raw signal 804b is measured by the strain sensor 705b; the raw signal 804c is measured by the strain sensor 705c; the raw signal 804d is measured by the strain sensor 705d; the raw signal 804e is measured by the strain sensor 705e; and the raw signal 804f is measured by the strain sensor 705f. The magnitude of peaks 805a-f in the signals measured by each sensor depends on the wheel-rail contact force and basically on the wheel portion that contacts the rail in that instant. When the wheel is healthy, the signal peaks 805a-f have similar magnitudes.

Referring back to FIG. 7, in an implementation, more rounds of the wheel 703 rotation in the test rig 700 is equivalent to an increase in the number of sensors. In each round of rotation, 6 sensors 705a-f sample the wheel 703. Therefore, for example, 10 rounds of the wheel 703 rotation is equivalent to sampling with 60 sensors.

In this example, the wheel rotates around the test rig 700 with a rotational speed of 20 rpm. Each of the four sample wheels, namely, the healthy wheel, the first defective wheel, the second defective wheel, and the third defective wheel were rotated around the test rig 700 for 10 rounds. The samples collected by each sensor in the effective zone of the sensor were then collected and sent to the signal processing unit, and all the samples were mapped over the circumferential coordinate of the wheel according to Equations (1)-(4) to obtain a reconstructed signal for each wheel. In this example, each sensor sampled 11 samples in its respective effective zone.

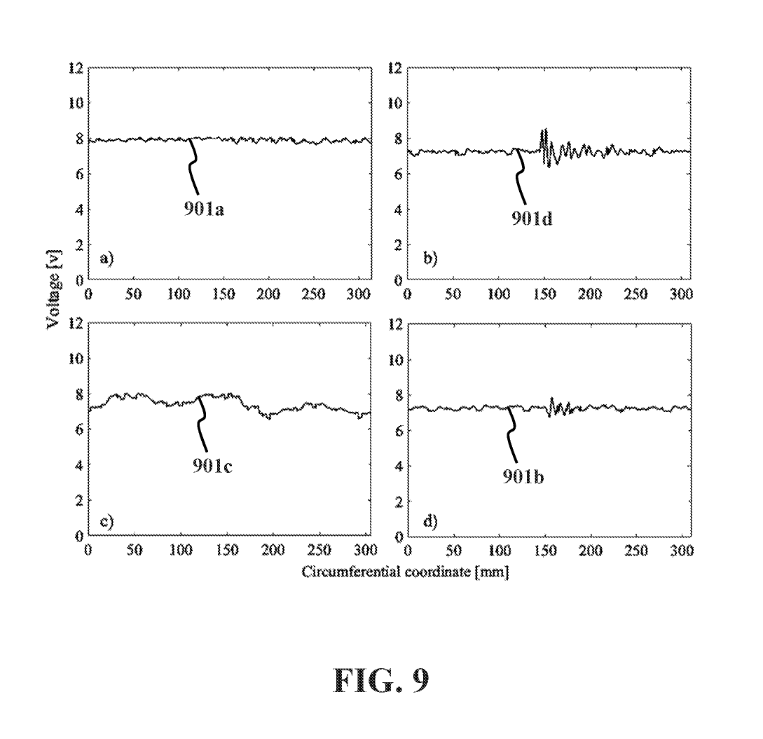

FIG. 9 illustrates reconstructed signals 901a-d for the healthy wheel and three defective wheels. The reconstructed signal 901a belongs to the healthy wheel; the reconstructed signal 901b belongs to the first defective wheel; the reconstructed signal 901c belongs to the second defective wheel; and the reconstructed signal 901d belongs to the third defective wheel. The reconstructed signal 901a has very small deviation from the average. The reconstructed signals 901b-d have more deviations from their averages which indicates the existence of the wheel defects but fails in providing detailed insight about the defects.

In this example, three classifiers SVM, 1-NN, and 3-NN are used for classification of the reconstructed signals. In order to generate a reference dataset for training the classifiers, four wheels with eight different velocities and three different loads are tested. Therefore, the reference dataset has 96 objects. The first, second, and third defective wheels along with the healthy wheel form four classes. The wheel rotational velocities that are used in the tests are 13.3, 20, 26.6, 33.3, 40, 46.6, 53.3, and 60 RPM. The wheel loads are 1.07, 1.25, and 1.6 kN.

Referring to FIG. 7, in these experimental tests, the length of the effective zone is 5 mm, and the wheel 703 velocities and diameters are known. Since the test rig 700 has a circular structure, any changes in the wheel-rail contact point change the passing curve of the wheel 703 and consequently the sensors 705a-f intervals. The middle point of the rail 704 has a diameter of approximately 1007.5 mm. The measurements showed that the contact point varied between 1004.5 to 1008 mm depending on the wheel 703 velocity and load. Therefore, the rail 704 circumference varied between 3155.7 to 3166.7 mm and as a result, the sensors intervals varied between 525.9 to 527.7 mm. For this specific sensor configuration, the distribution of the samples collected by the sensors 705a-f can be simulated to determine the required number of sensors to cover the wheels circumferences.

The reference reconstructed signals are interpolated with 1 mm intervals to obtain interpolated signals with uniform distribution of the samples over the circumferential coordinate. Seven features are calculated based on the reference reconstructed signals, namely, the peak value, dynamic value, and the ratio of the peak to the average, and four K-dimensional vectors including the reconstructed signal, dynamic signal, ratio signal, and the normalized signal. In addition to these features, the frequency transform of these signals are used in this example. To transfer the signals into the frequency domain, the Fast Fourier transform is applied to the signals. Therefore, four other signals are generated by transferring the signals into the frequency domain. The amplitude of the transferred signals used as the feature required.

Three classifiers, SVM, 1-NN and 3-NN, are investigated using a 10-fold cross validation. To train the classifiers, the reference dataset is divided into 10 subsets. The classifiers are trained on the first nine subsets and are tested by the remaining subset. Since, the selection of the train set and test set is random, the process is repeated 20 times.

TABLE 2

| | | | Standard Deviation |
|---|---|---|---|
| Feature | Classifier | Error [%] | of the Error [%] |
| Peak Value | SVM | 75 | 0.33 |
| | 1-NN | 48.33 | 1.03 |
| | 3-NN | 39.42 | 1.66 |
| Dynamic Value | SVM | 55.72 | 0.53 |
| | 1-NN | 16.19 | 1.28 |
| | 3-NN | 12.6 | 1.5 |
| Ratio Value | SVM | 75 | 0 |
| | 1-NN | 26.14 | 1.38 |
| | 3-NN | 25.72 | 1.62 |
| Reconstructed Signal | SVM | 26.04 | 2.48 |
| | 1-NN | 16.77 | 1.34 |
| | 3-NN | 18.43 | 0.96 |
| Dynamic Signal | SVM | 34.94 | 2.09 |
| | 1-NN | 47.6 | 0.68 |
| | 3-NN | 48.38 | 0.71 |
| Ratio Signal | SVM | 35.1 | 1.01 |
| | 1-NN | 45 | 0.54 |
| | 3-NN | 47.08 | 0.42 |
| Normalized Signal | SVM | 28.59 | 2.47 |
| | 1-NN | 33.64 | 1.12 |
| | 3-NN | 34.47 | 1.58 |
| Fourier Transform of the | SVM | 14.06 | 1.73 |
| Reconstructed Signal | 1-NN | 4.06 | 0.46 |
| | 3-NN | 6.3 | 0.92 |
| Fourier Transform of the | SVM | 14.37 | 1.92 |
| Dynamic Signal | 1-NN | 4.42 | 0.57 |
| | 3-NN | 6.14 | 0.82 |
| Fourier Transform of the | SVM | 16.3 | 1.85 |
| Ratio Signal | 1-NN | 8.22 | 0.82 |
| | 3-NN | 10.1 | 0.9 |
| Fourier Transform of the | SVM | 22.7 | 2.2 |
| Normalized Signal | 1-NN | 22.08 | 1.41 |
| | 3-NN | 18.95 | 1.19 |

Table 2 presents the average and the standard deviation of the errors after 20 repetitions for three classifiers and for 11 different feature extraction methods using the dataset generated by laboratory tests. The results presented in Table 2 show that the Frequency features provide much better performance. For example, 1-NN classifier using Fourier transform of reconstructed and dynamic signals classified the wheels with around 4% error. These results validates the wheel defect identification model.

While the foregoing has described what are considered to be the best mode and/or other examples, it is understood that various modifications may be made therein and that subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study, except where specific meanings have otherwise been set forth herein. Relational terms such as “first” and “second” and the like may be used solely to distinguish one entity or action from another without necessarily requiring or implying any actual such relationship or order between such entities or actions. The terms “comprises,” “comprising,” or any other variation thereof, as used herein and in the appended claims are intended to cover a non-exclusive inclusion, encompassing a process, method, article, or apparatus that comprises a list of elements that does not include only those elements but may include other elements not expressly listed to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is not intended to be used to interpret or limit the scope or meaning of the claims. In addition, in the foregoing Detailed Description, it can be seen that various features are grouped together in various implementations. Such grouping is for purposes of streamlining this disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into this Detailed Description, with each claim standing on its own as a separately claimed subject matter.

While various implementations have been described, the description is intended to be exemplary, rather than limiting and it will be apparent to those of ordinary skill in the art that many more implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A system for detecting and identifying defects of a railway wheel, the system comprising:
a plurality of sensors mounted on a rail of a railway track, each sensor from the plurality of sensors configured to collect samples from a portion of the railway wheel circumference and generate a sensor signal including an array of the samples;
a signal processing unit coupled with the plurality of sensors, the signal processing unit comprising:
a processor; and
a memory configured to store executable instructions to cause the processor to perform operations to process arrays of samples received from the plurality of sensors to detect and identify the defects of the railway wheel, the operations comprising:
mapping the array of samples received from each of the plurality of sensors over the railway wheel circumference by calculating a corresponding position of each sample of the array of samples in a circumferential coordinate of the railway wheel, the mapped arrays of samples from the plurality of sensors forming a reconstructed signal; and
classifying the reconstructed signal, based at least in part on a defect type and a defect severity.

2. The system according to claim 1, wherein calculating a corresponding position of each sample of the array of samples in a circumferential coordinate of the railway wheel comprises calculating the corresponding position by an operation defined by:
$${Y}_{m , n} = {X}_{m} - ( {L}_{w} \times ⌊ \frac{{X}_{m}}{{L}_{w}} ⌋ ) + ( ( n - 1 ) \times λ )$$
where, Y_{m,n} is the corresponding position of an nth sample in the array of samples picked up by an mth sensor, Xₘ is the position of the mth sensor with respect to a first sensor, L_{w} is the railway wheel circumference length, λ is the spacial distance between the samples, and operator [ ] is the rounding operator toward the nearest integer less than or equal to the term between the operator.

3. The system according to claim 2, wherein the space distance between the samples is calculated by dividing the railway wheel velocity to sampling frequency of the plurality of the sensors.

4. The system according to claim 1, wherein classifying the reconstructed signal, based at least in part on a defect type and a defect severity comprises:
generating a reference dataset including a plurality of reference reconstructed signals from railway wheels with known defect types and seventies;
calculating reference features of the reference dataset, the reference features including peak values of the reference reconstructed signals, dynamic values of the reference reconstructed signals, ratios of the peak values to average values, interpolated reference reconstructed signals, dynamic signals, ratio signals, normalized signals, Fourier transforms of the interpolated reconstructed signals, Fourier transforms of the dynamic signals, Fourier transforms of the ratio signals, Fourier transforms of the normalized signals, combinations thereof;
training a classifier by the reference features of the reference reconstructed signals; and
classifying the reconstructed signal by the trained classifier.

5. The system according to claim 4, wherein classifying the reconstructed signal by the trained classifier comprises:
calculating features of the reconstructed signal, the features of the reconstructed signal including a peak value of the reconstructed signal, a dynamic value of the reconstructed signal, a ratio of the peak value to average value of the reconstructed signal, interpolated reference reconstructed signal, dynamic signal, ratio signal, normalized signal, a Fourier transform of the interpolated reconstructed signal, a Fourier transforms of the dynamic signal, a Fourier transforms of the ratio signal, a Fourier transforms of the normalized signal, and combinations thereof; and
identifying a defect type and severity for the reconstructed signal by comparing the features of the reconstructed signal with the reference features of the reference reconstructed signals by the classifier.

6. The system according to claim 4, wherein the classifier is selected from the group consisting of a support vector machine and a k-nearest neighbor algorithm.

7. A method of detecting and identifying defects of a railway wheel by implementing a plurality of sensors mounted on a rail of a railway track, each sensor from the plurality of sensors being configured to collect samples from a portion of the railway wheel circumference and generate a sensor signal including an array of the samples, the method comprising the steps of:
mapping the array of samples received from each of the plurality of sensors over the railway wheel circumference by calculating a corresponding position of each sample of the array of samples in a circumferential coordinate of the railway wheel, the mapped arrays of samples from the plurality of sensors forming a reconstructed signal; and
classifying the reconstructed signal, based at least in part on a defect type and a defect severity.

8. The method according to claim 7, wherein calculating a corresponding position of each sample of the array of samples in a circumferential coordinate of the railway wheel comprises calculating the corresponding position by an operation defined by:
$${Y}_{m , n} = {X}_{m} - ( {L}_{w} \times ⌊ \frac{{X}_{m}}{{L}_{w}} ⌋ ) + ( ( n - 1 ) \times λ )$$
where, Y_{m,n} is the corresponding position of an nth sample in the array of samples picked up by an mth sensor, Xₘ is the position of the mth sensor with respect to a first sensor, L_{w} is the railway wheel circumference length, A is the space distance between the samples, and operator [ ] is the round operator toward the nearest integer less than or equal to the term between the operator.

9. The system according to claim 8, wherein the spacial distance between the samples is calculated by dividing the railway wheel velocity to sampling frequency of the plurality of the sensors.

10. The system according to claim 7, wherein classifying the reconstructed signal, based at least in part on a defect type and a defect severity comprises:
generating a reference dataset including a plurality of reference reconstructed signals from railway wheels with known defect types and seventies;
calculating reference features of the reference dataset, the reference features including peak values of the reference reconstructed signals, dynamic values of the reference reconstructed signals, ratios of the peak values to average values, interpolated reference reconstructed signals, dynamic signals, ratio signals, normalized signals, Fourier transforms of the interpolated reconstructed signals, Fourier transforms of the dynamic signals, Fourier transforms of the ratio signals, Fourier transforms of the normalized signals, combinations thereof;
training a classifier by the reference features of the reference reconstructed signals; and
classifying the reconstructed signal by the trained classifier.

11. The system according to claim 10, wherein classifying the reconstructed signal by the trained classifier comprises:
calculating features of the reconstructed signal, the features of the reconstructed signal including a peak value of the reconstructed signal, a dynamic value of the reconstructed signal, a ratio of the peak value to average value of the reconstructed signal, interpolated reference reconstructed signal, dynamic signal, ratio signal, normalized signal, a Fourier transform of the interpolated reconstructed signal, a Fourier transforms of the dynamic signal, a Fourier transforms of the ratio signal, a Fourier transforms of the normalized signal, and combinations thereof; and
identifying a defect type and severity for the reconstructed signal by comparing the features of the reconstructed signal with the reference features of the reference reconstructed signals by the classifier.

12. The system according to claim 10, wherein the classifier is selected from the group consisting of a support vector machine and a k-nearest neighbor algorithm.
